(19) United States
(12) Patent Application Publication
(10) Pub. No.: US 2026/0268321 A1
(43) Pub. Date: Sep. 10, 2026

(54) METHOD AND SYSTEMS FOR FACILITATING PRE-AUTHORIZATION TRANSACTIONS

(71) Applicant: MASTERCARD INTERNATIONAL INCORPORATED, Purchase, NY (US)

(72) Inventors: Ashish KUMAR, Lucknow (IN); Priyanka CHUDASAMA, New Delhi (IN); Tushar Pandurang KADAM, Navi Mumbai (IN); Sarthak MALIK, Muzaffarnagar (IN); Aakarsh MALHOTRA, NEW DELHI (IN); Gaurav DHAMA, White Plains, NY (US)

(73) Assignee: MASTERCARD INTERNATIONAL INCORPORATED, Purchase, NY (US)

(21) Appl. No.: 19/069,308

(22) Filed: Mar. 4, 2025

(51) Int. Cl. G06Q 20/40

(52) U.S. Cl. CPC G06Q 20/401; G06Q 20/4097

(57) ABSTRACT

A method for facilitating pre-authorization transactions is provided. A pre-authorization transaction request associated with a merchant and a payment mode is received. Further, payment mode feature values associated with the payment mode and merchant feature values associated with the merchant are retrieved from a memory. The payment mode feature values, the merchant feature values, pre-authorization feature values associated with the pre-authorization transaction request, and a probability of an incremental authorization request associated with the pre-authorization transaction request are inputted to a trained machine learning (ML) model. In response, a degree of change in the transaction amount at a time of settlement of the pre-authorization transaction request is obtained as an output of the trained ML model. The degree of change in the transaction amount is one of, more than the transaction amount, less than the transaction amount, or same as the transaction amount.

### FIELD

Various embodiments of the present disclosure relate generally to pre-authorization transactions. More particularly, various embodiments of the present disclosure relate to methods and systems for facilitating pre-authorization transactions.

### BACKGROUND

Pre-authorization transactions refer to transactions in which, at the time of initial authorization, a pre-authorization amount is placed on hold in a payment account of a user. The pre-authorization amount is typically based on a projected sale amount provided by a merchant. During a pre-authorization transaction request, an issuer associated with the user reserves the pre-authorization amount in the payment account. The reserved amount is intended to be utilized for settlement of the pre-authorization transaction at a future time. However, the amount required for settlement at the time of clearing of the pre-authorization transaction differs from the pre-authorization amount. Thus, issuers face additional challenges due to daily limits on the funds that can be settled.

In light of the foregoing, there is a need for a technical solution that solves the abovementioned problems.

### SUMMARY

Methods and systems for facilitating pre-authorization transactions are provided substantially as shown in and described in connection with, at least one of the figures, as set forth more completely in the claims.

In an embodiment of the present disclosure, a method for facilitating pre-authorization transactions is provided. The method includes receiving, by a server, a pre-authorization transaction request associated with a merchant and a payment mode. The method further includes retrieving, by the server from a memory, a first plurality of feature values associated with the payment mode and a second plurality of feature values associated with the merchant. The method includes inputting, by the server, the first plurality of feature values, the second plurality of feature values, a plurality of pre-authorization feature values associated with the pre-authorization request, and a probability of an incremental authorization request associated with the pre-authorization transaction request, as an input to a trained first machine learning (ML) model. Further, the method includes obtaining, by the server, based on the input, a degree of change in the transaction amount at a time of settlement of the pre-authorization transaction request as an output of the trained first ML model.

In another embodiment, a method for training a first machine learning (ML) model for facilitating pre-authorization transactions is provided. The method includes creating, by a server, a first plurality of feature values associated with each payment mode of a plurality of payment modes and a second plurality of feature values associated with each merchant of a plurality of merchants. The plurality of payment modes and the plurality of merchants are associated with a plurality of historical pre-authorization transactions. The method further includes training, by the server, the first ML model, based on the created first plurality of feature values, the created second plurality of feature values, and a plurality of incremental transaction request probabilities associated with the plurality of historical pre-authorization transactions. The first ML model is operable to output a degree of change in a transaction amount of a pre-authorization transaction request with a merchant and a payment mode at a time of settlement based on the training.

In yet another embodiment, a system for facilitating pre-authorization transactions is provided. The system includes a memory and processing circuitry coupled to the memory. The memory is configured to store a trained first machine learning (ML) model. The processing circuitry is configured to receive a pe-authorization transaction request associated with a merchant and a payment mode. Further, the processing circuitry is configured to retrieve, from the memory, a first plurality of feature values associated with the payment mode and a second plurality of feature values associated with the merchant. Further, the processing circuitry is configured to input the first plurality of feature values, the second plurality of feature values, a plurality of pre-authorization feature values associated with the pre-authorization transaction request, and a probability of an incremental authorization request associated with the pre-authorization transaction request, as an input to the trained first ML model. The processing circuitry is further configured to obtain, based on the input, a degree of change in the transaction amount at a time of settlement as an output of the trained first ML model.

In some embodiments, the method further includes inputting, by the server, the first plurality of feature values, the second plurality of feature values, and the plurality of pre-authorization feature values, to a trained second ML model. Further, the method includes obtaining, by the server, the probability of the incremental authorization request associated with the pre-authorization transaction request as an output of the trained second ML model. The probability of the incremental authorization request associated with the pre-authorization transaction request is outputted based on the first plurality of feature values, the second plurality of feature values, and the plurality of pre-authorization feature values

In another embodiment, the method further includes transmitting, by the server, the degree of change in the transaction amount and the probability of the incremental authorization request, to an issuer server associated with the payment mode.

In some embodiments, the method further includes creating, by the server, the first plurality of feature values based on first historical transaction data associated with the payment mode and the second plurality of feature values based on second historical transaction data associated with the merchant. Further, the method includes storing, by the server, the first plurality of feature values and the second plurality of feature values in the memory.

In some embodiments, the first plurality of feature values and the second plurality of feature values are created and stored periodically.

In some embodiments, the first plurality of feature values and the second plurality of feature values are created and stored prior to the reception of the pre-authorization transaction request.

In some embodiments, the method further includes generating, by the server, the plurality of pre-authorization feature values based on the pre-authorization transaction request.

In some embodiments, the method further includes storing, by the server, the first ML model in a memory upon the training.

In some embodiments, the first plurality of feature values and the second plurality of feature values are created based on the plurality of historical pre-authorization transactions.

In some embodiments, the method further includes creating, by the server, a third plurality of feature values associated with each payment mode of the plurality of payment modes and a fourth plurality of feature values associated with each merchant of the plurality of merchants. Further, the method includes training, by the server, a second ML model, based on the created third plurality of feature values, and the created fourth plurality of feature values.

In some embodiments, the method further includes storing, by the server, the second ML model in a memory upon the training.

In some embodiments, the third plurality of feature values and the fourth plurality of feature values are created based on the plurality of historical pre-authorization transactions.

### BRIEF DESCRIPTION OF THE DRAWINGS

The accompanying drawings illustrate the various embodiments of systems, methods, and other aspects of the disclosure. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

Various embodiments of the present disclosure are illustrated by way of example, and not limited by the appended figures, in which like references indicate similar elements:

FIG. 1 is a block diagram that illustrates a system environment for facilitating pre-authorization transactions, in accordance with an exemplary embodiment of the present disclosure;

FIG. 2 is a block diagram that illustrates a payment network server of the system environment of FIG. 1, in accordance with an exemplary embodiment of the present disclosure;

FIG. 3 represents a block diagram that illustrates training of a first machine learning (ML) model and implementation of a trained first ML model, in accordance with an exemplary embodiment of the present disclosure;

FIG. 4 represents a block diagram that illustrates training of a second ML model and implementation of a trained second ML model, in accordance with an exemplary embodiment of the present disclosure;

FIG. 5 represents a high-level flowchart that illustrates a method for facilitating pre-authorization transactions, in accordance with an exemplary embodiment of the present disclosure;

FIG. 6 represents a high-level flowchart that illustrates a method for training the second ML model, in accordance with an exemplary embodiment of the present disclosure;

FIGS. 7A-7D, collectively, represents a flowchart that illustrates a method for facilitating pre-authorization transactions by the payment network server, in accordance with an exemplary embodiment of the present disclosure; and

FIG. 8 is a block diagram that illustrates a system architecture of a computer system 800 of the system environment of FIG. 1, in accordance with an exemplary embodiment of the present disclosure.

Further areas of applicability of the present disclosure will become apparent from the detailed description provided hereinafter. It should be understood that the detailed description of exemplary embodiments is intended for illustration purposes only and is, therefore, not intended to necessarily limit the scope of the present disclosure.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. In one example, the teachings presented and the needs of a particular application may yield multiple alternate and suitable approaches to implement the functionality of any detail described herein. Therefore, any approach may extend beyond the particular implementation choices in the following embodiments that are described and shown.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Pre-authorization transactions refer to transactions where at the time of initial authorization, a pre-authorization amount is put on hold in a payment account of a user based on a projected sale amount associated with a merchant. During a pre-authorization transaction request by a merchant, an issuer associated with the user reserves the pre-authorization amount in the payment account of the user such that the pre-authorization amount can be utilized for settlement at a future time period. However, during the time of settlement, an actual amount for settlement varies from the pre-authorization amount. Additionally, an issuer has a limited amount of funds that can be settled in a day. Thus, when the actual amount for settlement exceeds the pre-authorization amount, the issuer may not settle the pre-authorization transaction. Further, an incremental authorization request may follow the pre-authorization transaction requesting indicating the issuer to change the pre-authorization amount, thereby further increasing uncertainty for the issuer in reserving funds for facilitating pre-authorization transactions. In other words, the fund allocation and clearing process in pre-authorization transactions is complicated for issuers, given the daily settlement limits. Thus, there is a need for a solution to overcome the above-mentioned problems.

Various embodiments of the present disclosure disclose a method and a system for facilitating pre-authorization transactions. The method includes retrieving feature values associated with a merchant and a payment mode associated with a pre-authorization transaction request, from a memory. Further, pre-authorization features are generated based on the pre-authorization transaction request. The retrieved feature values, the generated pre-authorization features, and a probability of incremental authorization request for the pre-authorization transaction request are inputted to a trained machine learning (ML) model. Further, a degree of change in a pre-authorization amount at a time of settlement of the pre-authorization transaction request is obtained as an output of the trained machine learning model. The pre-authorization amount is associated with the pre-authorization transaction request. The degree of change in the pre-authorization amount at the time of settlement of the pre-authorization transaction request may be one of less than the pre-authorization amount, same as the pre-authorization amount, and greater than the pre-authorization amount. The degree of change in the pre-authorization amount and the probability of incremental authorization request are transmitted to the issuer server. Thus, the issuer server may reserve adequate funds for the pre-authorization transaction request based on the degree of change in the pre-authorization amount and the probability of incremental authorization request. As a result, seamless clearing of pre-authorization transactions is facilitated by the present disclosure.

Payment mode is a medium that is utilized to initiate payment transactions. Examples of the payment mode include a payment card, a digital wallet, a virtual payment address, or the like.

Merchant refers to an individual or a business entity that offers various products and/or services in exchange for payments. The merchant may establish a merchant account with a financial institution, such as a bank to accept the payments from several users.

Server is a physical or cloud data processing system on which a server program runs. A server may be implemented in hardware or software, or a combination thereof. In one embodiment, the server is implemented as a computer program that is executed on programmable computers, such as personal computers, laptops, or a network of computer systems. The server may correspond to an acquirer server, a payment network server, or an issuer server.

Issuer is a financial institution, such as a bank, where accounts of several users are established and maintained. The issuer ensures payment for approved transactions in accordance with various payment network regulations and local legislation.

Payment networks act as intermediate entities between acquirer banks and issuer banks to authenticate and fund transactions.

A pre-authorization transaction refers to a transaction where a temporary hold is placed on a pre-authorization amount in a user payment account of a user based on a pre-authorization transaction request by a merchant. The pre-authorization amount is reserved and utilized during a settlement of the pre-authorization transaction at a future time period.

Machine-learning (ML) model refers to a model that is realized by one or more ML algorithms that learn patterns from training data to one of classify new data, predict a result based on the new data, or make decisions based on the new data. Examples of a machine-learning algorithm may include but are not limited to, K-means clustering, hierarchical clustering, decision trees, neural networks, linear regression, Random Forest, support vector machines, or the like.

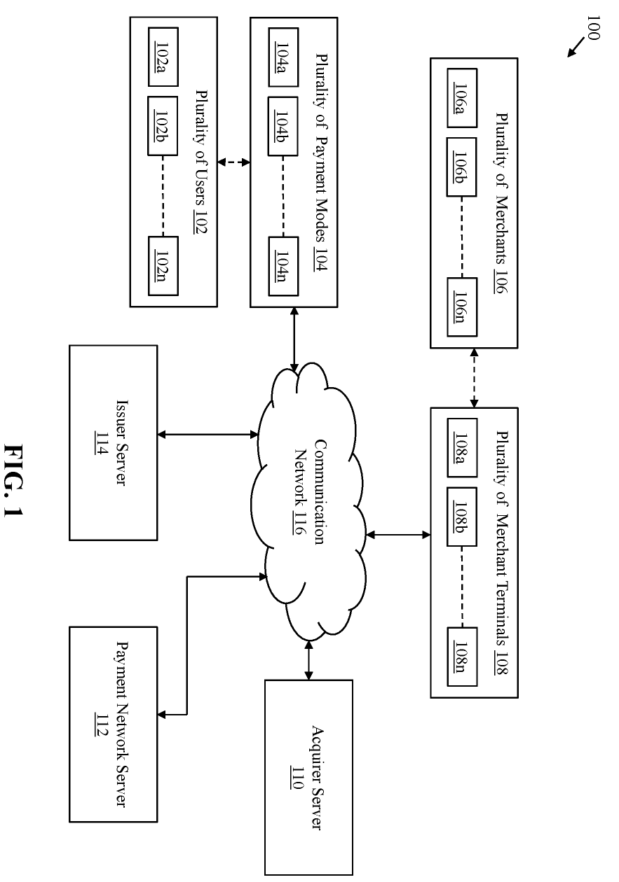

FIG. 1 is a block diagram that illustrates a system environment 100 for facilitating pre-authorization transactions, in accordance with an exemplary embodiment of the present disclosure. The system environment 100 may include a plurality of users 102, a plurality of payment modes 104, a plurality of merchants 106, a plurality of merchant terminals 108, an acquirer server 110, a payment network server 112, an issuer server 114, and a communication network 116. The plurality of merchant terminals 108, the acquirer server 110, the payment network server 112, and the issuer server 114 may communicate with each other by way of the communication network 116 or through a separate communication network established there between.

The plurality of users 102 may include a first user 102a, a second user 102b, …, and an nth user 102n. Each user of the plurality of users 102 may be associated with one or more user payment accounts maintained at a financial institution such as an issuer. Examples of the user payment account may include a savings account, a current account, a debit account, a credit account, a digital wallet account, or the like. Further, the plurality of payment modes 104 may include a first payment mode 104a, a second payment mode 104b, …, and an nth payment mode 104n.

The plurality of payment modes 104 may be associated with the plurality of users 102. Each user of the plurality of users 102 may utilize a corresponding payment mode to perform one or more pre-authorization transactions associated with a corresponding user payment account. The plurality of payment modes 104 are issued to the plurality of users 102 by the issuer. In an example, the first payment mode 104a may be utilized by the first user 102a to perform a pre-authorization transaction. The first payment mode 104a is a medium that facilitates the first user 102a to access the corresponding user payment account maintained at the issuer. Examples of the plurality of payment modes 104 may include but are not limited to, a payment card, a digital wallet, a virtual payment address (VPA), or the like. A payment card may be either a physical payment card or a virtual payment card. Examples of the payment card may include, but are not limited to, a credit card, a debit card, a prepaid card, a gift card, a rewards card, a loyalty points card, a frequent flyer miles card, or the like.

One or more users of the plurality of users 102 may perform pre-authorization transactions with one or more merchants of the plurality of merchants 106 for one or more services or products offered by the corresponding one or more merchants. The plurality of merchants 106 may include a first merchant 106a, a second merchant 106b, …, and an nth merchant 106n. Each merchant of the plurality of merchants 106 may correspond to an individual or a business entity that offers products and/or services in exchange for funds. Additionally, each merchant of the plurality of merchants 106 may have a merchant payment account maintained at the financial institution such as an acquirer to receive funds. Each merchant of the plurality of merchants 106 may provide one or more services/products. In an example, the first merchant 106a may provide cab services and the second merchant 106b may provide hotel services.

A pre-authorization transaction refers to a transaction where a temporary hold is placed on a pre-authorization amount in a user payment account of a user based on a pre-authorization transaction request by a merchant. The pre-authorization amount is reserved and utilized during a settlement of the pre-authorization transaction at a future time period.

The plurality of merchant terminals 108 may include a first merchant terminal 108a, a second merchant terminal 108b, …, and an nth merchant terminal 108n. The plurality of merchant terminals 108 are associated with the plurality of merchants 106. Further, each merchant terminal of the plurality of merchant terminals 108 may be utilized by a corresponding merchant to facilitate pre-authorization transactions with one or more users of the plurality of users 102. Examples of the plurality of merchant terminals 108 may include but are not limited to a point-of-sale device, a kiosk, or the like.

In a scenario, the first user 102a may opt for a cab service at the first merchant 106a. The first user 102a may inform the first merchant 106a that the cab service is needed for eight days. Further, the first merchant 106a may request the first user 102a for the first payment mode 104a associated with the first user 102a to initiate a pre-authorization transaction request. The pre-authorization transaction request is associated with a pre-authorization transaction between the first payment mode 104a and the first merchant 106a. The first merchant 106a may initiate the pre-authorization transaction request by way of the first merchant terminal 108a. In an example, when the first payment mode 104a is the physical payment card, the first payment mode 104a may be swiped on the first merchant terminal 108a or tapped on the first merchant terminal 108a for initiating the pre-authorization transaction request. Additionally, a transaction amount associated with the pre-authorization transaction request and a hold period associated with the pre-authorization transaction request may be entered by the first merchant 106a to the first merchant terminal 108a to initiate the pre-authorization transaction request.

The transaction amount corresponds to an amount estimated by the first merchant 106a for offering the cab service to the first user 102a for eight days. The hold period corresponds to a time period until which the transaction amount is requested to be reserved in the user payment account of the first user 102a. The transaction amount may be settled with the first merchant 106a after completion of the hold period. The pre-authorization transaction request may be indicative of the transaction amount, the hold period, an identifier of the first payment mode 104a, an identifier of the first merchant 106a, a merchant category code of the first merchant 106a, a timestamp, and the like. The merchant payment account of the first merchant 106a is maintained at the acquirer server 110. Thus, the first merchant terminal 108a may transmit the pre-authorization transaction request to the acquirer server 110.

The acquirer server 110 may include suitable logic, circuitry, interface, and/or code, executable by the circuitry, for facilitating pre-authorization transactions. The acquirer server 110 may be maintained by an acquirer. The acquirer is a financial institution that manages one or more merchant payment accounts of various merchants, e.g., one or more merchants of the plurality of merchants 106. The acquirer maintains a plurality of merchant payment accounts. The plurality of merchant payment accounts include the merchant payment account of the first merchant 106a. Thus, the acquirer server 110 receives the pre-authorization transaction request from the first merchant terminal 108a. The acquirer server 110 determines that the payment network server 112 is associated with the first payment mode 104a based on the pre-authorization transaction request. Further, the acquirer server 110 transmits the pre-authorization transaction request to the payment network server 112.

The payment network server 112 may include suitable logic, circuitry, interfaces, and/or code, executable by the circuitry that may be configured to perform one or more operations for facilitating pre-authorization transactions. The payment network server 112 may be maintained by a payment card association, a digital payment service provider, or the like. The payment network server 112 acts as an intermediary between the acquirer server 110 and the issuer server 114 for facilitating pre-authorization transactions between the plurality of users 102 and the plurality of merchants 106.

The payment network server 112 may have access to first payment mode historical transaction data associated with each payment mode of the plurality of payment modes 104. The first payment mode historical transaction data of each payment mode may include details of a plurality of historical pre-authorization transactions and a plurality of historical transactions, associated with the corresponding payment mode. The details of a historical pre-authorization transaction may include a timestamp, a transaction amount, a settling amount, a payment mode identifier, a merchant identifier, a merchant category code, a product/service associated with the historical pre-authorization transaction, a status of the historical transaction (such as declined or successful), an indication of whether an incremental authorization request is associated, an indication whether the historical pre-authorization transaction is fraudulent, and the like. The details of a historical transaction may include a timestamp, a transaction amount, a payment mode identifier, a merchant identifier, a merchant category code, a product/service associated with the historical transaction, a status of the historical transaction (such as declined or successful), an indication whether the historical transaction is fraudulent, or the like.

The payment network server 112 may further have access to first merchant historical transaction data associated with each merchant of the plurality of merchants 106. The first merchant historical transaction data of each merchant may include details of a plurality of historical pre-authorization transactions and a plurality of historical transactions, associated with the corresponding merchant. The first payment mode historical transaction data and the first merchant historical transaction data may be associated with a first time period. In an example, the first time period is six months. In another example, the first time period is one year. In yet another example, the first time period is four months.

The payment network server 112 may be configured to create a first plurality of payment mode feature values associated with each payment mode of the plurality of payment modes 104 and a first plurality of merchant feature values associated with each merchant of the plurality of merchants 106. The payment network server 112 may create the first plurality of payment mode feature values associated with each payment mode based on the first payment mode historical transaction data associated with the corresponding payment mode. Similarly, the payment network server 112 may create the first plurality of merchant feature values associated with each merchant based on the first merchant historical transaction data associated with the corresponding merchant. Additionally, the first plurality of payment mode feature values are associated with a first plurality of payment mode features, and the first plurality of merchant feature values are associated with a first plurality of merchant features.

The first plurality of payment mode features may include at least two of a percentage of cleared pre-authorization transactions in a first time period, a percentage of cleared transactions in the first time period, a percentage of cleared incremental authorization transactions in the first time period, an average transaction amount of incremental authorization transactions cleared with the same amount in the first time period, and an average transaction amount of incremental authorization transactions cleared with less amount in the first time period. The first plurality of payment mode features may further include an average transaction amount of incremental authorization transactions cleared with more amount in the first time period, an average transaction amount of pre-authorization transactions cleared with the same amount in the first time period, and an average transaction amount of pre-authorization transactions cleared with less amount in the first time period.

The first plurality of payment mode features may further include an average time to clear incremental authorization transactions in the first time period, an average time to clear transactions in the first time period, an average time to clear pre-authorization transactions in the first time period, an average transaction amount of cleared transactions in the first time period, a percentage of approved pre-authorization transactions in the first time period, a percentage of approved incremental authorization transactions in the first time period, and the like.

The first plurality of merchant features may include at least two of a percentage of cleared pre-authorization transactions in the first time period, a percentage of cleared transactions in the first time period, a percentage of cleared incremental authorization transactions in the first time period, an average transaction amount of incremental authorization transactions cleared with the same amount in the first time period, and an average transaction amount of incremental authorization transactions cleared with less amount in the first time period. The first plurality of merchant features may further include an average transaction amount of incremental transactions cleared with more amount in the first time period, an average transaction amount of pre-authorization transactions cleared with the same amount in the first time period, and an average transaction amount of pre-authorization transactions cleared with less amount in the first time period.

The first plurality of merchant features may further include an average time to clear incremental authorization transactions in the first time period, an average time to clear transactions in the first time period, an average time to clear pre-authorization transactions in the first time period, an average transaction amount of cleared transactions in the first time period, a percentage of approved pre-authorization transactions in the first time period, a percentage of approved incremental authorization transactions in the first time period, and the like.

The payment network server 112 may be further configured to train a first machine learning (ML) model based on the created first plurality of payment mode feature values and the created first plurality of merchant feature values. The first ML model is operable to output a probability of an incremental authorization request for a pre-authorization transaction request associated with a merchant and a payment mode based on the training. An incremental authorization request corresponds to a transaction request associated with a pre-authorization transaction request. The incremental authorization request may be initiated after approval of the associated pre-authorization request. The incremental authorization request may be indicative of a request to increase or decrease a transaction amount associated with the pre-authorization transaction request and/or increase or decrease a hold period associated with the pre-authorization transaction request.

The payment network server 112 may be further configured to create a second plurality of payment mode feature values associated with each payment mode of the plurality of payment modes 104 and a second plurality of merchant feature values associated with each merchant of a plurality of merchants 106. The payment network server 112 may create the second plurality of payment mode feature values associated with each payment mode based on the first payment mode historical transaction data associated with the corresponding payment mode. Similarly, the payment network server 112 may create the second plurality of merchant feature values associated with each merchant based on the first merchant historical transaction data associated with the corresponding merchant. Additionally, the second plurality of payment mode feature values are associated with a second plurality of payment mode features, and the second plurality of merchant feature values are associated with a second plurality of merchant features.

In some embodiments, the second plurality of payment mode features may be similar to the first plurality of payment mode features. Similarly, the second plurality of merchant features may be similar to the first plurality of merchant features. The payment network server 112 may be configured to train a second ML model based on the created second plurality of payment mode feature values, the created second plurality of merchant feature values, and a plurality of incremental authorization request probabilities. The plurality of incremental authorization request probabilities may be obtained based on the training of the first ML model. The plurality of incremental authorization request probabilities may be associated with the plurality of historical pre-authorization transactions associated with the plurality of payment modes 104 and the plurality of merchants 106. The second ML model may be operable to output a degree of change in a transaction amount of a pre-authorization transaction request associated with a merchant and a payment mode at a time of settlement based on the training. The degree of change may correspond to one of less than the transaction amount, same as the transaction amount, and more than the transaction amount.

The payment network server 112 may be further configured to store the trained first ML model and the trained second ML model in a memory associated with the payment network server 112. Implementation of the trained first ML model and the trained second ML model are explained in the forthcoming description.

The payment network server 112 may be further configured to create a third plurality of payment mode feature values associated with each payment mode of the plurality of payment modes 104 based on second payment mode historical transaction data associated with a corresponding payment mode. Further, the payment network server 112 may be further configured to create a third plurality of merchant feature values associated with each merchant of the plurality of merchants 106 based on second merchant historical transaction data associated with a corresponding merchant. The second payment mode historical transaction data and the second merchant historical transaction data are associated with a second time period. The second time period occurs after the first time period. In an example, the second time period is four months. In another example, the second time period is six weeks.

The third plurality of payment mode feature values are associated with a third plurality of payment mode features. Similarly, the third plurality of merchant feature values are associated with a third plurality of merchant features. The payment network server 112 may be further configured to store the created third plurality of payment mode feature values and the created third plurality of merchant feature values in the memory.

The third plurality of payment mode features may include at least two of a percentage of cleared pre-authorization transactions in a second time period, a percentage of cleared transactions in the second time period, a percentage of cleared incremental transactions in the second time period, an average transaction amount of incremental transactions cleared with the same amount in the second time period, and an average transaction amount of incremental transactions cleared with less amount in the second time period. The third plurality of payment mode features may further include an average transaction amount of incremental transactions cleared with more amount in the second time period, an average transaction amount of pre-authorization transactions cleared with the same amount in the second time period, and an average transaction amount of pre-authorization transactions cleared with less amount in the second time period.

The third plurality of payment mode features may further include an average time to clear incremental transactions in the second time period, an average time to clear transactions in the second time period, an average time to clear pre-authorization transactions in the second time period, an average transaction amount of cleared transactions in the second time period, a percentage of approved pre-authorization transactions in the second time period, a percentage of approved incremental transactions in the second time period, and the like.

The third plurality of merchant features may include at least two of a percentage of cleared pre-authorization transactions in a second time period, a percentage of cleared transactions in the second time period, a percentage of cleared incremental transactions in the second time period, an average transaction amount of incremental transactions cleared with the same amount in the second time period, and an average transaction amount of incremental transactions cleared with less amount in the second time period. The third plurality of merchant features may further include an average transaction amount of incremental transactions cleared with more amount in the second time period, an average transaction amount of pre-authorization transactions cleared with the same amount in a second time period, and an average transaction amount of pre-authorization transactions cleared with less amount in the second time period.

The third plurality of merchant features may further include an average time to clear incremental transactions in the second time period, an average time to clear transactions in the second time period, an average time to clear pre-authorization transactions in the second time period, an average transaction amount of cleared transactions in the second time period, a percentage of approved pre-authorization transactions in the second time period, a percentage of approved incremental transactions in the second time period, and the like.

In some embodiments, the third plurality of payment mode feature values and the third plurality of merchant feature values are created and stored, periodically. In an example, the third plurality of payment mode feature values and the third plurality of merchant feature values are created and stored, every four months.

Referring back to the above-described scenario, the payment network server 112 may receive the pre-authorization transaction request from the acquirer server 110. The pre-authorization transaction request is associated with the first payment mode 104a and the first merchant 106a. Further, the pre-authorization transaction request is indicative of the transaction amount, the hold period, the identifier of the first payment mode 104a, the identifier of the first merchant 106a, the merchant category code of the first merchant 106a, the time stamp, and the like. The payment network server 112 may be configured to retrieve the third plurality of payment mode feature values associated with the first payment mode 104a and the third plurality of merchant feature values associated with the first merchant 106a from the memory based on the reception of the pre-authorization transaction request.

The payment network server 112 may be further configured to generate a plurality of pre-authorization feature values based on the pre-authorization transaction request. The plurality of pre-authorization feature values may be associated with a plurality of pre-authorization features. The plurality of pre-authorization features may include the transaction amount, the merchant category code, a day of the week when the pre-authorization transaction request is initiated, and the like. The payment network server 112 may be further configured to input the retrieved third plurality of payment mode feature values, the retrieved third plurality of merchant feature values, and the plurality of pre-authorization feature values, to the trained first ML model. Further, the payment network server 112 may be configured to obtain a probability of an incremental authorization request associated with the pre-authorization transaction request as an output of the trained first ML model. The probability of the incremental authorization request may correspond to a prediction of whether an incremental authorization request will be initiated by the first merchant 106a for the pre-authorization transaction request. The probability of the incremental authorization request may correspond to a value between “0” and “1”. In an example, the value being greater than or equal to “0.6” indicates that there will be an incremental authorization request for the pre-authorization transaction request whereas the value being less than “0.6” indicates that there will be no incremental authorization request for the pre-authorization transaction request.

The payment network server 112 may be further configured to input the retrieved third plurality of payment mode feature values, the retrieved third plurality of merchant feature values, the plurality of pre-authorization feature values, and the probability of the incremental authorization request to the trained second ML model. Further, the payment network server 112 may be configured to obtain a degree of change in the transaction amount at a time of settlement as an output of the trained second ML model. The degree of change in the transaction amount is outputted based on the retrieved third plurality of payment mode feature values, the retrieved third plurality of merchant feature values, the plurality of pre-authorization feature values, and the probability of the incremental authorization request. Further, the degree of change in the transaction amount may be one of, more than the transaction amount, less than the transaction amount, or same as the transaction amount.

The payment network server 112 may be further configured to transmit the pre-authorization transaction request, the probability of the incremental authorization request, and the degree of change in the transaction amount at the time of settlement, to the issuer server 114.

The issuer server 114 may include suitable logic, circuitry, interface, and/or code, executable by the circuitry, for facilitating pre-authorization transactions. The issuer server 114 may be maintained by an issuer of the first payment mode 104a. The issuer is a financial institution that manages one or more user payment accounts of various users, e.g., the first user 102a. The issuer maintains a plurality of user payment accounts. The plurality of user payment accounts may include the user payment account of the first user 102a. The issuer server 114 may be configured to receive the pre-authorization transaction request, the probability of the incremental authorization request, and the degree of change in the transaction amount at the time of settlement, associated with the first payment mode 104a and the first merchant 106a, from the payment network server 112.

The issuer server 114 may be configured to reserve an amount in the user payment account for the pre-authorization transaction request based on the probability of the incremental authorization request and the degree of change in the transaction amount.

In an example, the issuer server 114 may reserve an amount that is greater than the transaction amount indicated in the pre-authorization transaction request based on the indication that there is a possibility of the incremental authorization request and the degree of change in the transaction amount is more than the transaction amount. Thus, during the time of settlement, the issuer server 114 may be well equipped to complete the pre-authorization transaction for a settling amount. Referring to the above-described example, the first user 102a may end up availing the cab service for ten days instead of eight days, thus the first merchant 106a may initiate the incremental authorization request on the ninth day to increase the transaction amount. Thus, for clearing the pre-authorization transaction, the first merchant 106a may request for the settling amount that is greater than the transaction amount. As the issuer server 114 reserved an amount that is greater than the transaction amount in the user payment account of the first user 102a, the issuer server 114 may seamlessly clear and settle the pre-authorization transaction.

Examples of the acquirer server 110, the payment network server 112, and the issuer server 114 may include, but are not limited to, computers, laptops, mini-computers, mainframe computers, any non-transient and tangible machines that may execute a machine-readable code, cloud-based servers, distributed server networks, a network of computer systems, or a combination thereof.

The communication network 116 may be a medium through which content and messages are transmitted between the plurality of merchant terminals 108, the acquirer server 110, the payment network server 112, and the issuer server 114. Examples of the communication network 116 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the system environment 100 may connect to the communication network 116 in accordance with various wired and wireless communication protocols, such as Transmission Control Protocol and Internet Protocol (TCP/IP), User Datagram Protocol (UDP), Long Term Evolution (LTE) communication protocols, or any combination thereof.

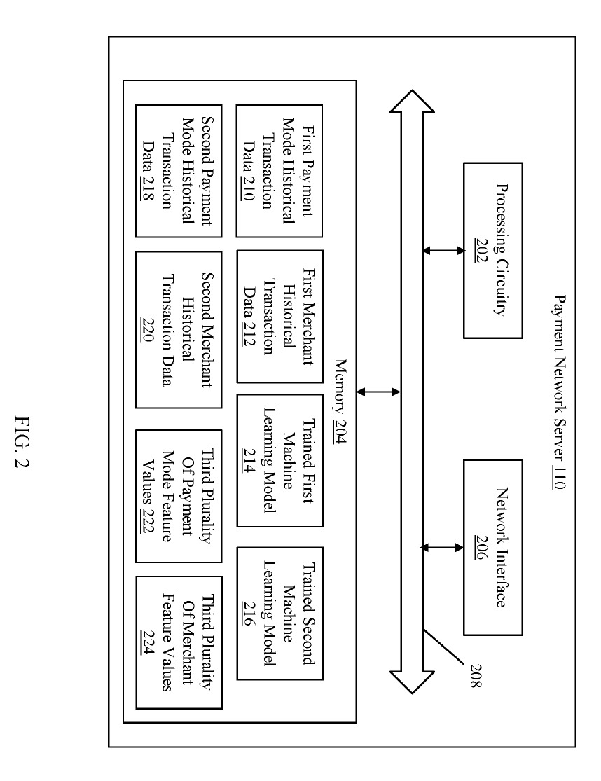

FIG. 2 is a block diagram that illustrates the payment network server 112, in accordance with an exemplary embodiment of the present disclosure. The payment network server 112 may include processing circuitry 202, a memory 204, and a network interface 206. The memory described in FIG. 1 is hereinafter referred to as the “memory 204”. The processing circuitry 202, the memory 204, and the network interface 206 may be communicatively coupled to each other by way of a communication bus 208.

The processing circuitry 202 may include suitable logic, circuitry, interfaces, and/or code for performing various operations to facilitate pre-authorization transactions. Examples of the processing circuitry 202 may include, but are not limited to, an application-specific integrated circuit (ASIC) processor, a reduced instruction set computer (RISC) processor, a complex instruction set computer (CISC) processor, a field programmable gate array (FPGA), a central processing unit (CPU), or the like.

The processing circuitry 202 may have access to the first payment mode historical transaction data associated with each payment mode of the plurality of payment modes 104. The first payment mode historical transaction data of each payment mode may include details of the plurality of historical pre-authorization transactions and the plurality of historical transactions, associated with the corresponding payment mode. The processing circuitry 202 may further have access to the first merchant historical transaction data associated with each merchant of the plurality of merchants 106. The first merchant historical transaction data of each merchant may include the details of the plurality of historical pre-authorization transactions and the plurality of historical transactions, associated with the corresponding merchant. The first payment mode historical transaction data and the first merchant historical transaction data may be associated with the first time period. In other words, the plurality of historical pre-authorization transactions and the plurality of historical transactions occurred during the first time period. The processing circuitry 202 may record the plurality of historical pre-authorization transactions and the plurality of historical transactions during the first time period and store the recorded plurality of historical pre-authorization transactions and plurality of historical transactions associated with plurality of payment modes 104 and the plurality of merchants 106 as the first payment mode historical transaction data (hereinafter referred to as the “first payment mode historical transaction data 210”) and the first merchant historical transaction data (hereinafter referred to as the “first merchant historical transaction data 212”) in the memory 204. Thus, the processing circuitry 202 may access the first payment mode historical transaction data 210 and the first merchant historical transaction data 212 whenever required.

The processing circuitry 202 may be configured to create the first plurality of payment mode feature values associated with each payment mode of the plurality of payment modes 104 and the first plurality of merchant feature values associated with each merchant of the plurality of merchants 106. The processing circuitry 202 may create the first plurality of payment mode feature values associated with each payment mode based on the first payment mode historical transaction data 210 associated with the corresponding payment mode. Similarly, the processing circuitry 202 may create the first plurality of merchant feature values associated with each merchant based on the first merchant historical transaction data 212 associated with the corresponding merchant. Additionally, the first plurality of payment mode feature values are associated with the first plurality of payment mode features, and the first plurality of merchant feature values are associated with the first plurality of merchant features.

The processing circuitry 202 may be further configured to train the first ML model based on the created first plurality of payment mode feature values and the created first plurality of merchant feature values. The first ML model is operable to output a probability of an incremental authorization request for a pre-authorization transaction request associated with a merchant and a payment mode based on the training. An incremental authorization request corresponds to a transaction request associated with a pre-authorization transaction request. The incremental authorization request may be initiated after approval of the associated pre-authorization request. The incremental authorization request may be indicative of a request to increase or decrease a transaction amount associated with the pre-authorization transaction request and/or increase or decrease a hold period associated with the pre-authorization transaction request.

The processing circuitry 202 may be further configured to create the second plurality of payment mode feature values associated with each payment mode of the plurality of payment modes 104 and the second plurality of merchant feature values associated with each merchant of a plurality of merchants 106. The payment network server 112 may create the second plurality of payment mode feature values associated with each payment mode based on the first payment mode historical transaction data 210 associated with the corresponding payment mode. Similarly, the payment network server 112 may create the second plurality of merchant feature values associated with each merchant based on the first merchant historical transaction data 212 associated with the corresponding merchant. Additionally, the second plurality of payment mode feature values are associated with the second plurality of payment mode features, and the second plurality of merchant feature values are associated with a second plurality of merchant features.

In some embodiments, the second plurality of payment mode features may be similar to the first plurality of payment mode features. Similarly, the second plurality of merchant features may be similar to the first plurality of merchant features. The processing circuitry 202 may be configured to train the second ML model based on the created second plurality of payment mode feature values, the created second plurality of merchant feature values, and a plurality of incremental authorization request probabilities. The plurality of incremental authorization request probabilities may be obtained based on the training of the first ML model. The plurality of incremental authorization request probabilities may be associated with the plurality of historical pre-authorization transactions associated with the plurality of payment modes 104 and the plurality of merchants 106. The second ML model may be operable to output a degree of change in a transaction amount of a pre-authorization transaction request associated with a merchant and a payment mode at a time of settlement based on the training. The degree of change may correspond to one of less than the transaction amount, same as the transaction amount, and more than the transaction amount.

An ML model refers to a model that is realized by one or more machine learning algorithms that learn patterns from training data to one of classify new data, predict a result based on the new data, or make decisions based on the new data. Examples of a machine learning algorithm may include but are not limited to, K-means clustering, hierarchical clustering, decision trees, neural networks, linear regression, Random Forest, support vector machines, or the like.

The processing circuitry 202 may be further configured to store the trained first ML model (hereinafter referred to as the “trained first ML model 214”) and the trained second ML model (hereinafter referred to as the “trained second ML model 216”) in the memory 204. Implementation of the trained first ML model 214 and the trained second ML model 216 are explained in the forthcoming description.

The processing circuitry 202 may be further configured to create the third plurality of payment mode feature values associated with each payment mode of the plurality of payment modes 104 based on the second payment mode historical transaction data (hereinafter referred to as the “second payment mode historical transaction data 218”) associated with a corresponding payment mode. Further, the processing circuitry 202 may be further configured to create the third plurality of merchant feature values associated with each merchant of the plurality of merchants 106 based on the second merchant historical transaction data (hereinafter referred to as the “second merchant historical transaction data 220”) associated with a corresponding merchant. The second payment mode historical transaction data 218 and the second merchant historical transaction data 220 are associated with the second time period. The second time period occurs after the first time period. In an example, the second time period is four months. In another example, the second time period is six weeks.

The third plurality of payment mode feature values are associated with the third plurality of payment mode features. Similarly, the third plurality of merchant feature values are associated with the third plurality of merchant features. The payment network server 112 may be further configured to store the created third plurality of payment mode feature values (hereinafter referred to as the “third plurality of payment mode feature values 222”) and the created third plurality of merchant feature values (hereinafter referred to as the “third plurality of merchant feature values 224”) in the memory 204.

In some embodiments, the third plurality of payment mode feature values 222 and the third plurality of merchant feature values 224 are created and stored, periodically. In an example, the third plurality of payment mode feature values 222 and the third plurality of merchant feature values 224 are created and stored, every four months.

The processing circuitry 202 may receive the pre-authorization transaction request from the acquirer server 110. The pre-authorization transaction request is associated with the first payment mode 104a and the first merchant 106a. Further, the pre-authorization transaction request is indicative of the transaction amount, the hold period, the identifier of the first payment mode 104a, the identifier of the first merchant 106a, the merchant category code of the first merchant 106a, the time stamp, and the like. The processing circuitry 202 may be configured to retrieve the third plurality of payment mode feature values 222 associated with the first payment mode 104a and the third plurality of merchant feature values 224 associated with the first merchant 106a from the memory 204 based on the reception of the pre-authorization transaction request.

The processing circuitry 202 may be further configured to generate the plurality of pre-authorization feature values based on the pre-authorization transaction request. The plurality of pre-authorization feature values may be associated with the plurality of pre-authorization features. The plurality of pre-authorization features may include the transaction amount, the merchant category code, a day of the week when the pre-authorization transaction request is initiated, and the like. The processing circuitry 202 may be further configured to input the retrieved third plurality of payment mode feature values 222, the retrieved third plurality of merchant feature values 224, and the plurality of pre-authorization feature values 312, to the trained first ML model 214. Further, the payment network server 112 may be configured to obtain the probability of an incremental authorization request associated with the pre-authorization transaction request as the output of the trained first ML model 214. The probability of the incremental authorization request may correspond to a prediction of whether an incremental authorization request will be initiated by the first merchant 106a for the pre-authorization transaction request. The probability of the incremental authorization request may correspond to a value between “0” and “1”. In an example, the value being greater than or equal to “0.5” indicates that there will be an incremental authorization request for the pre-authorization transaction request whereas the value being less than “0.5” indicates that there will be no incremental authorization request for the pre-authorization transaction request.

The processing circuitry 202 may be further configured to input the retrieved third plurality of payment mode feature values 222, the retrieved third plurality of merchant feature values 224, the plurality of pre-authorization feature values 312, and the probability of the incremental authorization request to the trained second ML model 216. Further, the processing circuitry 202 may be configured to obtain the degree of change in the transaction amount at the time of settlement of the pre-authorization transaction request as the output of the trained second ML model 216. The degree of change in the transaction amount is outputted based on the retrieved third plurality of payment mode feature values 222, the retrieved third plurality of merchant feature values 224, the plurality of pre-authorization feature values, and the probability of the incremental authorization request. Further, the degree of change in the transaction amount may be one of, more than the transaction amount, less than the transaction amount, or same as the transaction amount.

The processing circuitry 202 may be further configured to transmit the pre-authorization transaction request, the probability of the incremental authorization request, and the degree of change in the transaction amount 410 at the time of settlement, to the issuer server 114.

The memory 204 may include suitable logic, circuitry, and/or interfaces to store various instructions, ML models, or the like to facilitate pre-authorization transactions. For example, the memory 204 may store the first payment mode historical transaction data 210, the first merchant historical transaction data 212, the trained first machine learning model 214, the trained second machine learning model 216, the second payment mode historical transaction data 218, the second merchant historical transaction data 220, the third plurality of payment mode feature values 222, and the third plurality of merchant feature values 224. Examples of the memory 204 may include a random-access memory (RAM), a read-only memory (ROM), a programmable ROM (PROM), an erasable PROM (EPROM), a removable storage drive, a hard disk drive (HDD), a flash memory, a solid-state memory, or the like.

The network interface 206 may include suitable logic, circuitry, interfaces, and/or code, executable by the circuitry, to transmit and receive data over the communication network 116 using one or more communication network protocols. Examples of the network interface 206 may include but are not limited to, an antenna, a radio frequency transceiver, a wireless transceiver, a Bluetooth transceiver, an ethernet port, a universal serial bus (USB) port, or any other device configured to transmit and receive data.

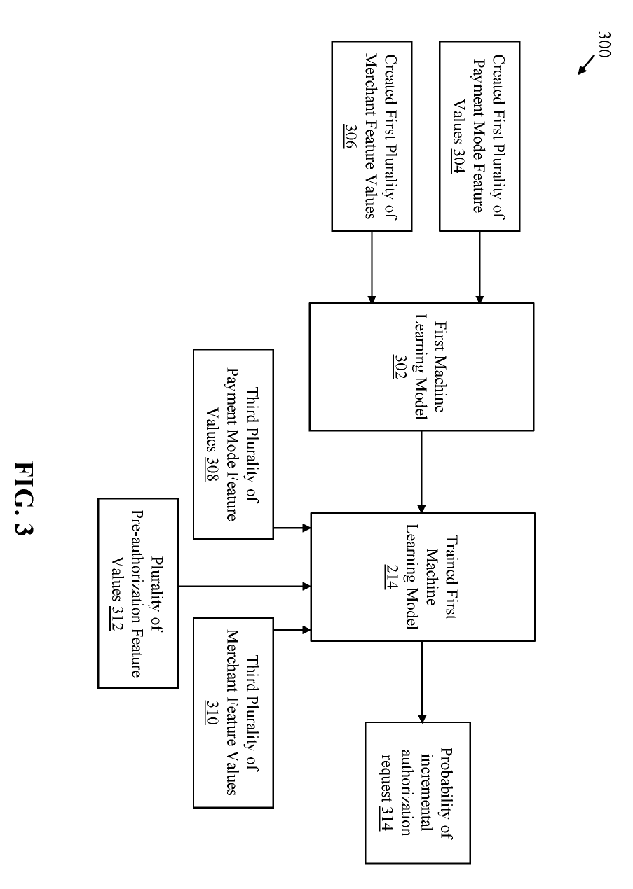

FIG. 3 represents a block diagram 300 that illustrates the training of the first ML model and implementation of the trained first ML model 214, in accordance with an exemplary embodiment of the present disclosure. The block diagram 300 is shown to include the first ML model (hereinafter referred to as the “first ML model 302”).

The processing circuitry 202 may train the first ML model 302 based on the created first plurality of payment mode feature values (hereinafter referred to as the “created first plurality of payment mode feature values 304”) and the created first plurality of merchant feature values (hereinafter referred to as the “created first plurality of merchant feature values 306”). The trained first ML model 214 may be obtained based on the training.

The first ML model 302 may learn weights and biases for each historical pre-authorization transaction based on the created first plurality of payment mode feature values 304 and the created first plurality of merchant feature values 306. The trained first ML model 214 may be obtained based on the training.

During the implementation of the trained first ML model 214, the third plurality of payment mode feature values (hereinafter referred to as the “third plurality of payment mode feature values 308”) associated with the first payment mode 104a, the third plurality of merchant feature values (hereinafter referred to as the “third plurality of merchant feature values 310”) associated with the first merchant 106a, and the plurality of pre-authorization feature values (hereinafter referred to as the “plurality of pre-authorization feature values 312”) are inputted to the trained first ML model 214.

In an example, the third plurality of payment mode feature values 308 may include 60% cleared pre-authorization transactions in the second time period, 80% cleared transactions in the second time period, a 55% cleared incremental transactions in the second time period, an average transaction amount of incremental transactions cleared with same amount in the second time period is 80$, and an average transaction amount of incremental transactions cleared with less amount in the second time period is 50$. The third plurality of payment mode feature values 308 may further include an average transaction amount of incremental transactions cleared with more amount in the second time period is 100$, an average transaction amount of pre-authorization transactions cleared with the same amount in the second time period is 400$, and an average transaction amount of pre-authorization transactions cleared with less amount in the second time period is 250$.

The third plurality of payment mode feature values 308 may further include an average time to clear incremental transactions in the second time period being fifteen days, an average time to clear transactions in the second time period is one day, an average time to clear pre-authorization transactions in the second time period is ten days, an average transaction amount of cleared transactions in the second time period is 70$, a percentage of approved pre-authorization transactions in the second time period is 70%, a percentage of approved incremental transactions in the second time period is 60%, and the like.

The third plurality of merchant feature values 310 may include a percentage of cleared pre-authorization transactions in the second time period being 74%, a percentage of cleared transactions in the second time period being 88%, a percentage of cleared incremental transactions in the second time period being 66%, an average transaction amount of incremental transactions cleared with same amount in the second time period is 700$, and an average transaction amount of incremental transactions cleared with less amount in the second time period is 300$. The third plurality of merchant feature values 310 may further include an average transaction amount of incremental transactions cleared with more amount in the second time period is 800$, an average transaction amount of pre-authorization transactions cleared with the same amount in the second time period is 600$, and an average transaction amount of pre-authorization transactions cleared with less amount in the second time period is 200$.

The third plurality of merchant feature values 310 may further include an average time to clear incremental transactions in the second time period is twenty days, an average time to clear transactions in the second time period is two days, an average time to clear pre-authorization transactions in the second time period is fifteen days, an average transaction amount of cleared transactions in the second time period is 150$, a percentage of approved pre-authorization transactions in the second time period is 62%, a percentage of approved incremental transactions in the second time period is 40%, and the like.

The plurality of pre-authorization feature values 312 may include 400$ as the transaction amount, “4121” as the merchant category code, “Wednesday” as the day of the week when the pre-authorization transaction request is initiated, and the like.

The trained first ML model 214 outputs the probability of an incremental authorization request (hereinafter referred to as the “probability of an incremental authorization request 314” based on the learned weights and biases, and received inputs.

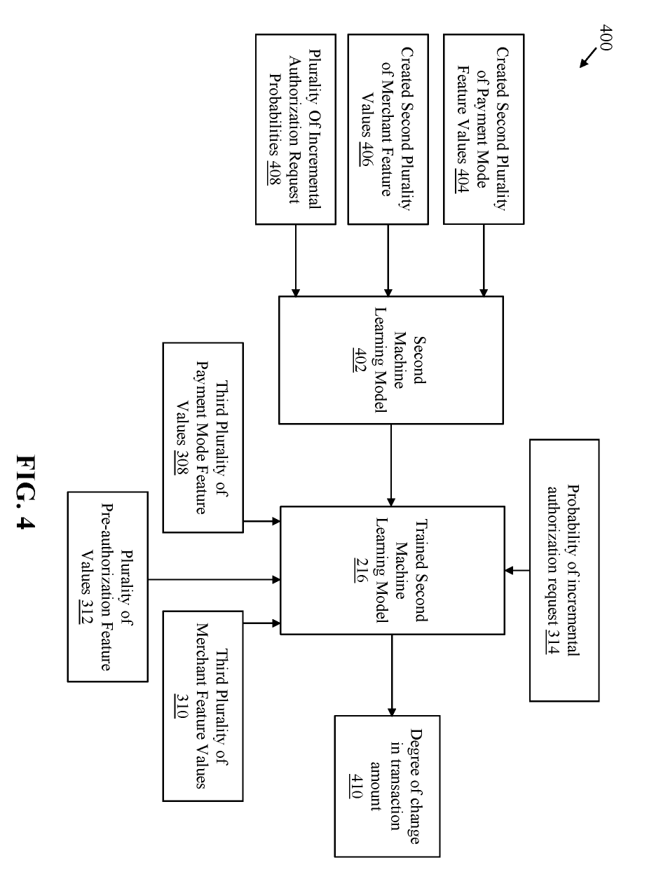

FIG. 4 represents a block diagram 400 that illustrates the training of the second ML model and implementation of the trained second ML model 216, in accordance with an exemplary embodiment of the present disclosure. The block diagram 400 is shown to include the second ML model (hereinafter referred to as the “second ML model 402”).

The processing circuitry 202 may train the second ML model 402 based on the created second plurality of payment mode feature values (hereinafter referred to as the “created second plurality of payment mode feature values 404”), the created second plurality of merchant feature values (hereinafter referred to as the “created second plurality of merchant feature values 406”), and the plurality of incremental authorization request probabilities (hereinafter referred to as the “plurality of incremental authorization request probabilities 408”). The trained second ML model 216 may be obtained based on the training.

The second ML model 402 may learn weights and biases for each historical pre-authorization transaction based on the created second plurality of payment mode feature values 404, the created second plurality of merchant feature values 406, and the plurality of incremental authorization request probabilities 408. The trained second ML model 216 may be obtained based on the training.

During the implementation of the trained second ML model 216, the third plurality of payment mode feature values 308, the third plurality of merchant feature values 310, the plurality of pre-authorization feature values 312, and the probability of an incremental authorization request 314 are inputted to the trained second ML model 216. The trained second ML model 216 outputs the degree of change in the transaction amount (hereinafter referred to as the “degree of change in the transaction amount 410”) at the time of settling based on the learned weights and biases, and received inputs. The degree of change in the transaction amount 410 may be one of less than the transaction amount, same as the transaction amount, or greater than the transaction amount.

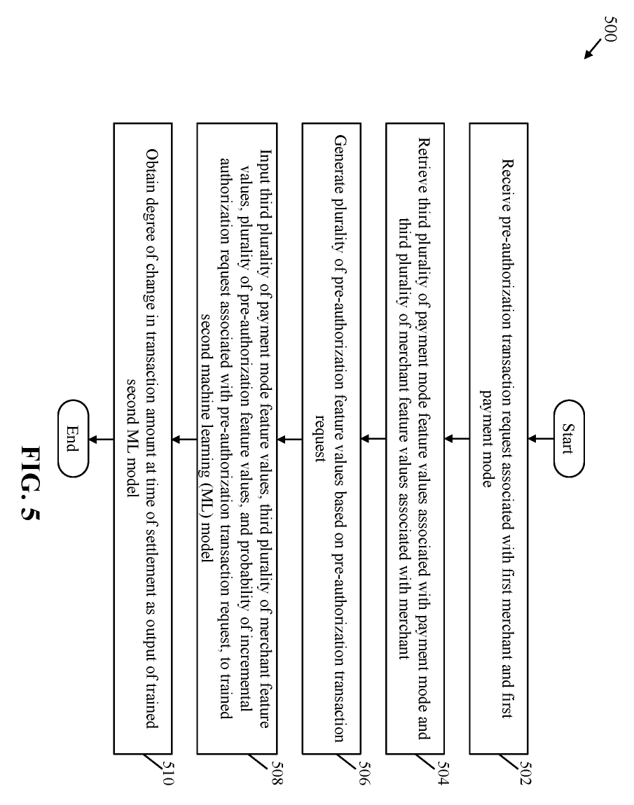

FIG. 5 represents a high-level flowchart 500 that illustrates a method (e.g., a process 500) for facilitating pre-authorization transactions, in accordance with an exemplary embodiment of the present disclosure.

At 502, the pre-authorization transaction request associated with the first merchant 106a and the first payment mode 104a is received by the payment network server 112. The pre-authorization transaction request is indicative of the transaction amount, the hold period, the identifier of the first payment mode 104a, the identifier of the first merchant 106a, the merchant category code of the first merchant 106a, the time stamp, and the like.

At 504, the third plurality of payment mode feature values 308 associated with the first payment mode 104a and the third plurality of merchant feature values 310 associated with the first merchant 106a are retrieved from the memory 204, by the payment network server 112.

At 506, the plurality of pre-authorization feature values 312 are generated by the payment network server 112 based on the pre-authorization transaction request. The plurality of pre-authorization feature values 312 may be associated with the plurality of pre-authorization features. The plurality of pre-authorization features may include the transaction amount, the merchant category code, a day of the week when the pre-authorization transaction request is initiated, and the like.

At 508, the third plurality of payment mode feature values 308, the second plurality of feature values, the third plurality of merchant feature values 310, and the probability of an incremental authorization request 314 associated with the pre-authorization transaction request are inputted to the trained second ML model 216 by the payment network server 112.

At 510, the degree of change in the transaction amount 410 at the time of settlement is obtained as the output of the trained second ML model 216 by the payment network server 112. The trained second ML model 216 outputs the degree of change in the transaction amount 410 based on the third plurality of payment mode feature values 308, the second plurality of feature values, the third plurality of merchant feature values 310, the plurality of pre-authorization feature values 312, and the probability of an incremental authorization request 314 associated with the pre-authorization transaction request. Further, the degree of change in the transaction amount 410 is one of, more than the transaction amount, less than the transaction amount, or same as the transaction amount.

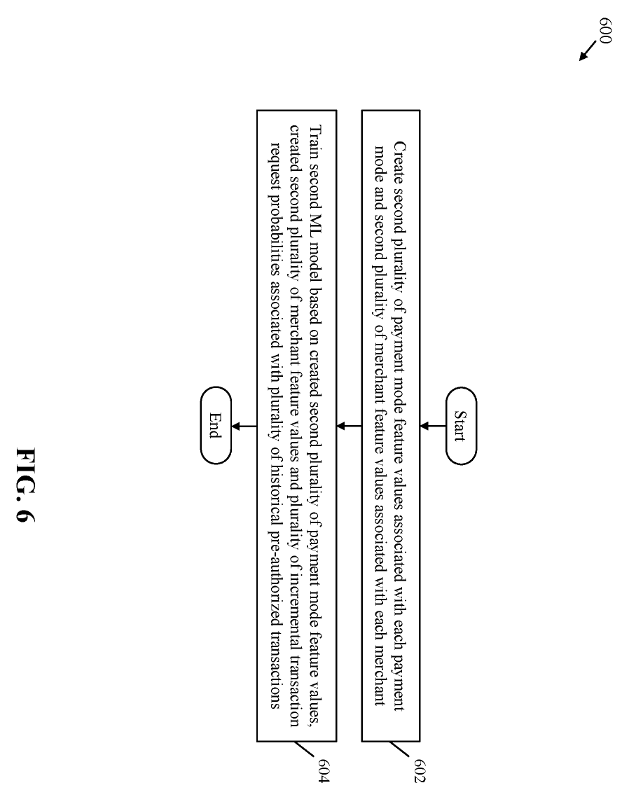

FIG. 6 represents a high-level flowchart 600 that illustrates a method (e.g., a process 500) for training the second ML model 402, in accordance with an exemplary embodiment of the present disclosure.

At 602, the second plurality of payment mode feature values associated with each payment mode of the plurality of payment modes 104 and the second plurality of merchant feature values associated with each merchant of the plurality of merchants 106 are created by the payment network server 112. The plurality of payment modes 104 and the plurality of merchants 106 are associated with the plurality of historical pre-authorization transactions.

At 604, the second ML model 402 is trained by the payment network server 112 based on the created second plurality of payment mode feature values 404, the created second plurality of merchant feature values 406, and the plurality of incremental authorization request probabilities 408 associated with the plurality of historical pre-authorization transactions. The second ML model 402 may be operable to output a degree of change in a transaction amount of a pre-authorization transaction request associated with a merchant and a payment mode at a time of settlement based on the training.

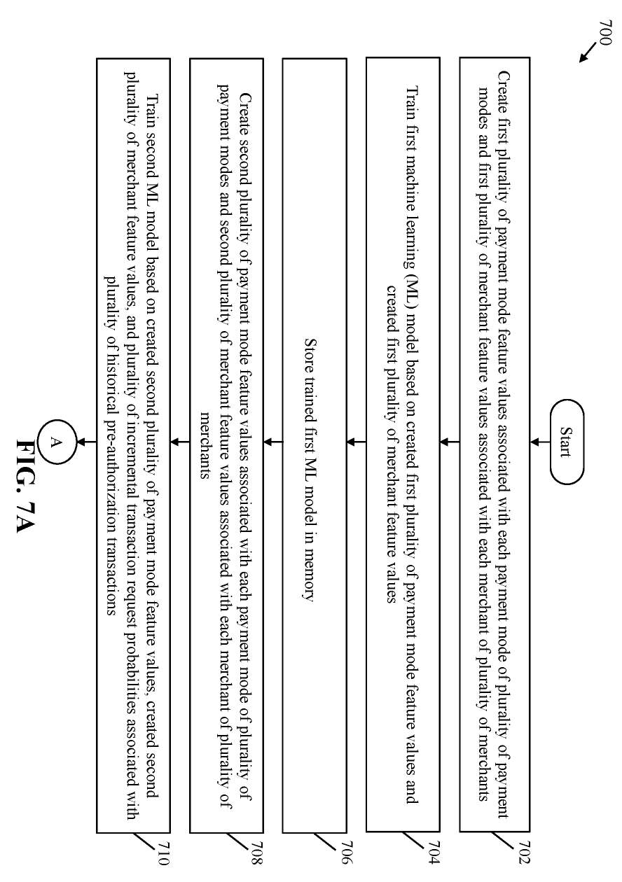

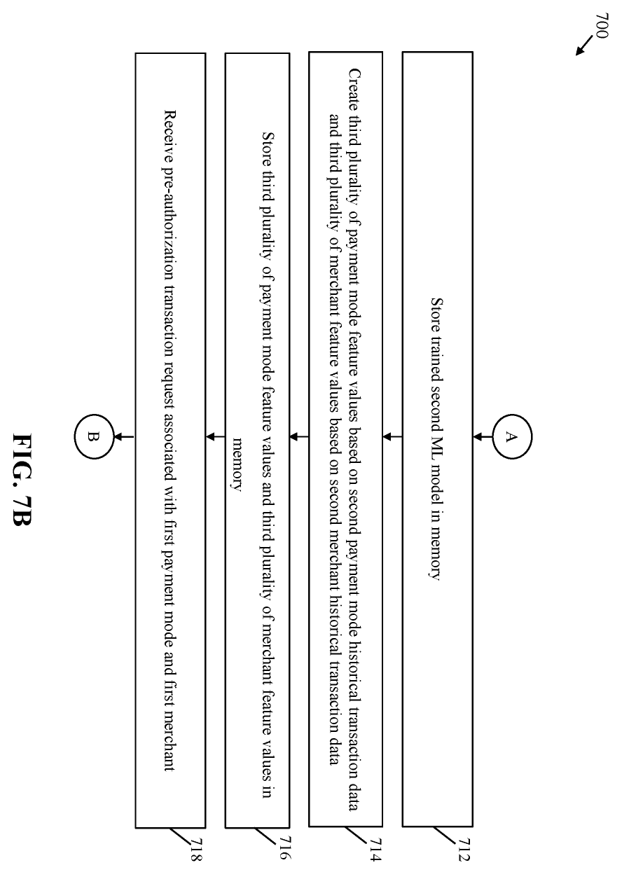

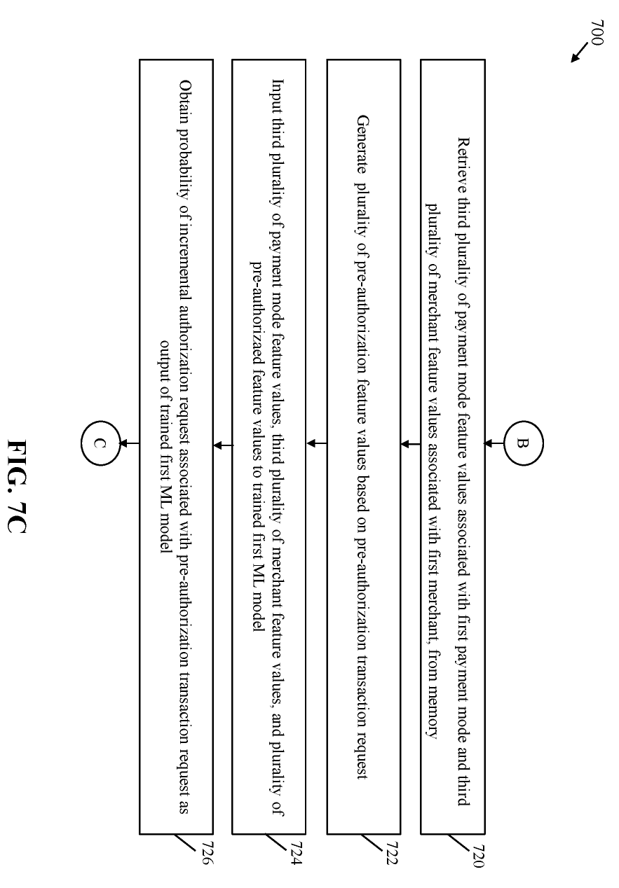

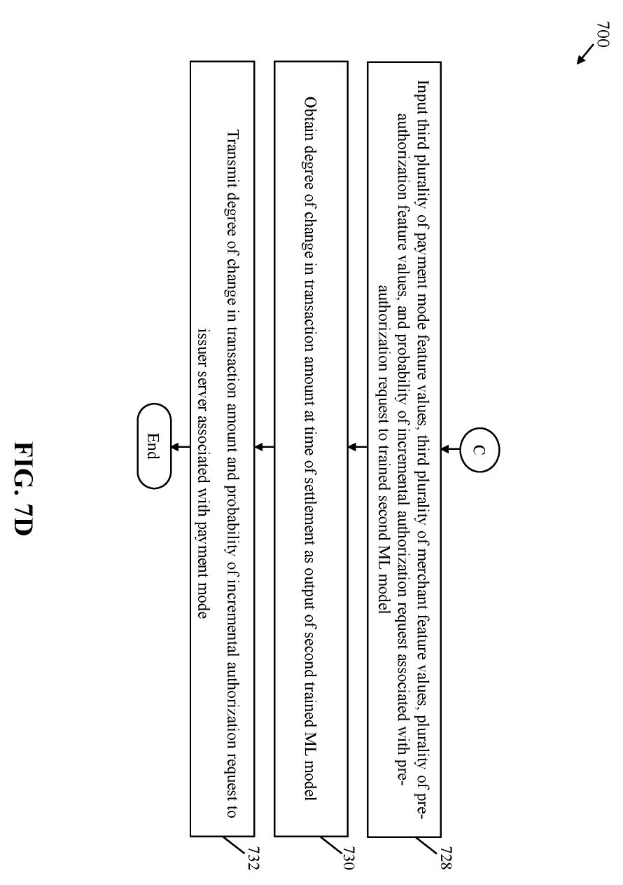

FIGS. 7A-7D, collectively, represents a flowchart 700 that illustrates a method (e.g., a process 700) for facilitating pre-authorization transactions by the payment network server 112, in accordance with an exemplary embodiment of the present disclosure.

Referring to FIG. 7A, at 702 the first plurality of payment mode feature values associated with each payment mode of the plurality of payment modes 104, and the first plurality of merchant feature values associated with each merchant of the plurality of merchants 106 are created by the payment network server 112. The payment network server 112 may create the first plurality of payment mode feature values associated with each payment mode based on the first payment mode historical transaction data 210 associated with the corresponding payment mode. Similarly, the payment network server 112 may create the first plurality of merchant feature values associated with each merchant based on the first merchant historical transaction data 212 associated with the corresponding merchant.

At 704, the first ML model 302 is trained by the payment network server 112 based on the created first plurality of payment mode feature values 304 and the created first plurality of merchant feature values 306. The first ML model 302 is operable to output a probability of an incremental authorization request for a pre-authorization transaction request associated with a merchant and a payment mode based on the training. Further, the incremental authorization request corresponds to the transaction request associated with a pre-authorization transaction request.

At 706, the trained first ML model 214 is stored in the memory 204 by the payment network server 112. At 708, the second plurality of payment mode feature values associated with each payment mode of the plurality of payment modes 104 and the second plurality of merchant feature values associated with each merchant of the plurality of merchants 106 are created by the payment network server 112. The second plurality of payment mode feature values 404 associated with each payment mode are created based on the first payment mode historical transaction data 210 associated with the corresponding payment mode. Similarly, the second plurality of merchant feature values 406 associated with each merchant are created based on the first merchant historical transaction data 212 associated with the corresponding merchant.

At 710, the second ML model 402 is trained by the payment network server 112 based on the created second plurality of payment mode feature values 404, the created second plurality of merchant feature values 406, and the plurality of incremental authorization request probabilities 408. The plurality of incremental authorization request probabilities 408 may be obtained based on the training of the first ML model 302. The plurality of incremental authorization request probabilities 408 may be associated with the plurality of historical pre-authorization transactions associated with the plurality of payment modes 104 and the plurality of merchants 106. The second ML model 402 may be operable to output the degree of change in the transaction amount of a pre-authorization transaction request associated with a merchant and the payment mode at a time of settlement based on the training. The degree of change may correspond to one of less than the transaction amount, same as the transaction amount, and more than the transaction amount.

Referring to FIG. 7B, at 712 the trained second ML model 216 is stored in the memory 204. At 714, the third plurality of payment mode feature values 308 associated with each payment mode of the plurality of payment modes 104 are created by the payment network server 112 based on the second payment mode historical transaction data 218 associated with a corresponding payment mode. Additionally, the third plurality of merchant feature values 310 associated with each merchant of the plurality of merchants 106 are created by the payment network server 112 based on the second merchant historical transaction data 220 associated with a corresponding merchant.

At 716, the created third plurality of payment mode feature values 308 and the created third plurality of merchant feature values 310 are stored in the memory 204 by the payment network server 112.

At 718, the pre-authorization transaction request is received by the payment network server 112. The pre-authorization transaction request is associated with the first payment mode 104a and the first merchant 106a. Further, the pre-authorization transaction request is indicative of the transaction amount, the hold period, the identifier of the first payment mode 104a, the identifier of the first merchant 106a, the merchant category code of the first merchant 106a, the time stamp, and the like.

Referring to FIG. 7C, at 720, the third plurality of payment mode feature values 308 associated with the first payment mode 104a and the third plurality of merchant feature values 310 associated with the first merchant 106a are retrieved from the memory 204 by the payment network server 112 based on the reception of the pre-authorization transaction request.

At 722, the plurality of pre-authorization feature values 312 are generated by the payment network server 112 based on the pre-authorization transaction request. The plurality of pre-authorization feature values 312 are associated with the plurality of pre-authorization features. The plurality of pre-authorization features may include the transaction amount, the merchant category code, a day of the week when the pre-authorization transaction request is initiated, and the like.

At 724, the retrieved third plurality of payment mode feature values 308, the retrieved third plurality of merchant feature values 310, and the plurality of pre-authorization feature values 312, are inputted to the trained first ML model 214 by the payment network server 112. Further at 726, the probability of an incremental authorization request 314 associated with the pre-authorization transaction request is obtained as the output of the trained first ML model 214 by the payment network server 112. The probability of the incremental authorization request 314 may correspond to a prediction of whether an incremental authorization request will be initiated by the first merchant 106a for the pre-authorization transaction request. The probability of the incremental authorization request may correspond to a value between “0” and “1”.

Referring to FIG. 7D, at 728, the retrieved third plurality of payment mode feature values 308, the retrieved third plurality of merchant feature values 310, the plurality of pre-authorization feature values 312, and the probability of the incremental authorization request 314 are inputted to the trained second ML model 216 by the payment network server 112. Further, at 730, the degree of change in the transaction amount 410 at the time of settlement is obtained as the output of the trained second ML model 216 by the payment network server 112. The degree of change in the transaction amount 410 is outputted based on the retrieved third plurality of payment mode feature values 308, the retrieved third plurality of merchant feature values 310, the plurality of pre-authorization feature values 312, and the probability of the incremental authorization request 314. The degree of change in the transaction amount 410 is one of less than the transaction amount, same as the transaction amount, and more than the transaction amount.

At 732, the pre-authorization transaction request, the probability of the incremental authorization request 314, and the degree of change in the transaction amount 410 at the time of settlement, are transmitted to the issuer server 114 by the payment network server 112.

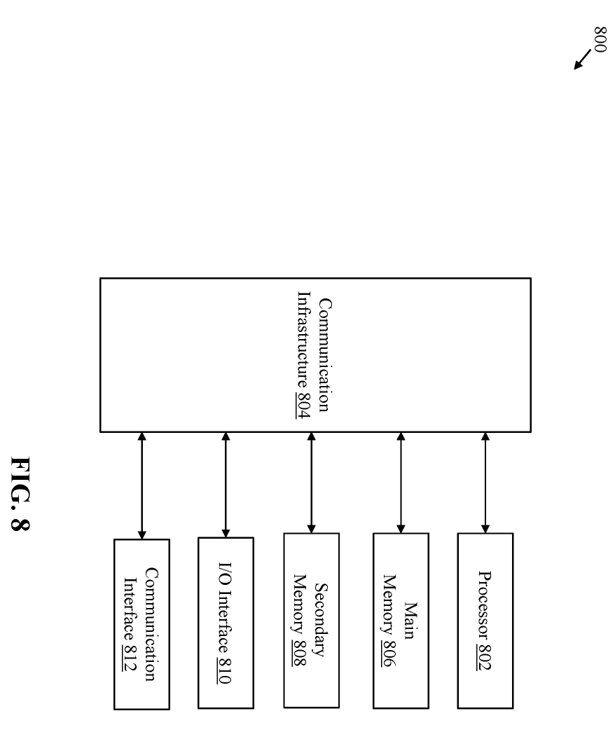

FIG. 8 is a block diagram that illustrates a system architecture of a computer system 800 of the system environment 100 of FIG. 1, in accordance with an exemplary embodiment of the present disclosure. An embodiment of disclosure, or portions thereof, may be implemented as computer-readable code on the computer system 800. In one example, the plurality of payment modes 104, the plurality of merchant terminals 108, the acquirer server 110, the payment network server 112, and the issuer server 114 may be implemented as the computer system 800. Hardware, software, or any combination thereof may embody modules and components used to implement the methods of FIGS. 5, 6, and 7A-D. The computer system 800 may include a processor 802, a communication infrastructure 804, a main memory 806, a secondary memory 808, an input/output (I/O) interface 810, and a communication interface 812.

The processor 802 may be a special-purpose or a general-purpose processing device. The processor 802 may be a single processor, multiple processors, or combinations thereof. Further, the processor 802 may be connected to the communication infrastructure 804, such as a bus, message queue, multi-core message-passing scheme, and the like.

The main memory 806 may be configured to store instructions that facilitate various operations described in conjunction with FIGS. 5, 6, 7A-D. Examples of the main memory 806 may include a random access memory (RAM), a read-only memory (ROM), and the like. The secondary memory 808 may include a hard disk drive (HDD) or a removable storage drive, such as a floppy disk drive, a magnetic tape drive, a compact disc, an optical disk drive, a flash memory, and the like. In an embodiment, the removable storage drive may be a non-transitory computer-readable medium.

The I/O interface 810 includes various input and output devices that are configured to communicate with the processor 802. Examples of the input devices may include a keyboard, a mouse, a joystick, a touchscreen, a microphone, and the like. Examples of the output devices may include a display screen, a speaker, headphones, and the like. The communication interface 812 may be configured to allow data to be transferred between the computer system 800 and various devices that are communicatively coupled to the computer system 800. Examples of the communication interface 812 may include a modem, a network interface, i.e., an Ethernet card, a communication port, and the like. Data transferred via the communication interface 812 may correspond to signals, such as electronic, electromagnetic, optical, or other signals as will be apparent to a person skilled in the art.

Embodiments in the present disclosure provide the system environment 100 and the method for facilitating pre-authorization transactions. The disclosed method includes obtaining the probability of an incremental authorization request for a pre-authorization transaction request. Additionally, a degree of change in the transaction amount associated with the pre-authorization transaction request is obtained. Further, the probability of the incremental authorization request and the degree of change in the transaction amount are transmitted to the issuer server 114. Thus, the issuer server 114 may allocate sufficient funds for the pre-authorization transaction request. As the degree of change in the transaction amount corresponds to one of less than the transaction amount, same as the transaction amount, and more than the transaction amount, the issuer server 114 may reserve sufficient funds for seamless clearing of the pre-authorization transaction. Thus, the present invention facilitates seamless facilitation of pre-authorization transactions.

Techniques consistent with the present disclosure provide, among other features, systems and methods for facilitating pre-authorization transactions. While various exemplary embodiments of the disclosed system and method have been described above, it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope. While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

While various embodiments of the present disclosure have been illustrated and described, it will be clear that the present disclosure is not limited to these embodiments only. Numerous modifications, changes, variations, substitutions, and equivalents will be apparent to those skilled in the art, without departing from the spirit and scope of the present disclosure, as described in the claims.

What is claimed is:

1. A method comprising:
receiving, by a server, a pre-authorization transaction request associated with a merchant and a payment mode, wherein the pre-authorization transaction request is indicative of a transaction amount;
retrieving, by the server from a memory, a first plurality of feature values associated with the payment mode and a second plurality of feature values associated with the merchant;
inputting, by the server, the first plurality of feature values, the second plurality of feature values, a plurality of pre-authorization feature values associated with the pre-authorization transaction request, and a probability of an incremental authorization request associated with the pre-authorization transaction request, as an input to a trained first machine learning (ML) model; and
obtaining, by the server, based on the input, a degree of change in the transaction amount at a time of settlement of the pre-authorization transaction request as an output of the trained first ML model.

2. The method of claim 1, further comprising:
inputting, by the server, the first plurality of feature values, the second plurality of feature values, and the plurality of pre-authorization feature values, to a trained second ML model; and
obtaining, by the server, the probability of the incremental authorization request associated with the pre-authorization transaction request as an output of the trained second ML model, wherein the probability of the incremental authorization request associated with the pre-authorization transaction request is outputted based on the first plurality of feature values, the second plurality of feature values, and the plurality of pre-authorization feature values.

3. The method of claim 2, further comprising transmitting, by the server, the degree of change in the transaction amount and the probability of the incremental authorization request, to an issuer server associated with the payment mode.

4. The method of claim 2, further comprising:
creating, by the server, the first plurality of feature values based on first historical transaction data associated with the payment mode and the second plurality of feature values based on second historical transaction data associated with the merchant; and
storing, by the server, the first plurality of feature values and the second plurality of feature values in the memory.

5. The method of claim 4, wherein the first plurality of feature values and the second plurality of feature values are created and stored periodically.

6. The method of claim 5, wherein the first plurality of feature values and the second plurality of feature values are created and stored prior to the reception of the pre-authorization transaction request.

7. The method of claim 1, further comprising generating, by the server, the plurality of pre-authorization feature values based on the pre-authorization transaction request.

8. The method of claim 1, wherein the degree of change in the transaction amount is one of, more than the transaction amount, less than the transaction amount, or same as the transaction amount.

9. A method comprising:
creating, by a server, a first plurality of feature values associated with each payment mode of a plurality of payment modes and a second plurality of feature values associated with each merchant of a plurality of merchants, wherein the plurality of payment modes and the plurality of merchants are associated with a plurality of historical pre-authorization transactions; and
training, by the server, a first machine learning (ML) model, based on the created first plurality of feature values, the created second plurality of feature values, and a plurality of incremental transaction request probabilities associated with the plurality of historical pre-authorization transactions, wherein the first ML model is operable to output a degree of change in a transaction amount of a pre-authorization transaction request with a merchant and a payment mode at a time of settlement based on the training.

10. The method of claim 9, further comprising storing, by the server, the first ML model in a memory upon the training.

11. The method of claim 9, wherein the first plurality of feature values and the second plurality of feature values are created based on the plurality of historical pre-authorization transactions.

12. The method of claim 9, further comprising:
creating, by the server, a third plurality of feature values associated with each payment mode of the plurality of payment modes and a fourth plurality of feature values associated with each merchant of the plurality of merchants; and
training, by the server, a second ML model, based on the created third plurality of feature values, and the created fourth plurality of feature values, wherein the second ML model is operable to output a probability of an incremental authorization request for a pre-authorization transaction request associated with a merchant and a payment mode based on the training.

13. The method of claim 12, further comprising storing, by the server, the second ML model in a memory upon the training.

14. The method of claim 12, wherein the third plurality of feature values and the fourth plurality of feature values are created based on the plurality of historical pre-authorization transactions.

15. A system comprising:
a memory configured to store a trained first machine learning (ML) model; and
processing circuitry coupled to the memory and configured to:
receive a pre-authorization transaction request associated with a merchant and a payment mode, wherein the pre-authorization transaction request is indicative of a transaction amount;
retrieve, from the memory, a first plurality of feature values associated with the payment mode and a second plurality of feature values associated with the merchant;
input the first plurality of feature values, the second plurality of feature values, a plurality of pre-authorization feature values associated with the pre-authorization transaction request, and a probability of an incremental authorization request associated with the pre-authorization transaction request, as an input to the trained first ML model; and
obtain, based on the input, a degree of change in the transaction amount at a time of settlement of the pre-authorization transaction request as an output of the trained first ML model.

16. The system of claim 15, wherein the memory is further configured to store a trained second ML model, and wherein the processing circuitry is further configured to:
input the first plurality of feature values, the second plurality of feature values, and the plurality of pre-authorization feature values, to the trained second ML model; and
obtain the probability of the incremental authorization request associated with the pre-authorization transaction request as an output of the trained second ML model.

17. The system of claim 16, wherein the processing circuitry is further configured to transmit the degree of change in the transaction amount and the probability of the incremental authorization request, to an issuer server associated with the payment mode.

18. The system of claim 15, wherein the processing circuitry is further configured to:
create the first plurality of feature values based on first historical transaction data associated with the payment mode and the second plurality of feature values based on second historical transaction data associated with the merchant; and
store the first plurality of feature values and the second plurality of feature values in the memory.

19. The system of claim 18, wherein the first plurality of feature values and the second plurality of feature values are created and stored periodically.

20. The system of claim 19, wherein the first plurality of feature values and the second plurality of feature values are created and stored prior to the reception of the pre-authorization transaction request.
